(19) United States
(12) Patent Application Publication
(10) Pub. No.: US 2002/0162966 A1
(43) Pub. Date: Nov. 7, 2002

(54) Method and apparatus for detecting surface defects in a plastic container

(76) Inventor: Lorinda L. Yoder, Monclova, OH (US)

Correspondence Address: MACMILLAN SOBANSKI & TODD, LLC, ONE MARITIME PLAZA FOURTH FLOOR, 720 WATER STREET, TOLEDO, OH, 43604-1619, US

(21) Appl. No.: 09/847,272

(22) Filed: May 2, 2001

(51) Int. Cl. G01N 21/90

(52) U.S. Cl. 250/372; 209/524

(57) ABSTRACT

A method for detecting defects in a surface of a container includes: providing a plastic container having a longitudinal axis and a surface; directing ultraviolet radiation from a source to an area of the surface; sensing a portion the ultraviolet radiation that is reflected from the surface of the plastic container; and generating a signal from the sensed portion of the ultraviolet radiation representing a defect in the surface plastic container.

### TECHNICAL FIELD

This invention relates to a method and apparatus for detecting and quantifying defects in a surface, and more particularly to a method and apparatus for detecting and quantifying stress cracks in a plastic container.

### BACKGROUND OF THE INVENTION

In many commercial markets, plastic containers such as polyethylene terephthalate (PET), blow molded bottles are designed to be returned to a bottle cleaning facility and reused in the range of about twenty uses per bottle. Over time, and as the number of uses increases, PET plastic bottles develop defects such as environmental stress cracks caused by excessive handling and degradation of the bottle surface. Typically, environmental stress cracks occur more frequently in the base of the bottles, although environmental stress cracks can occur at almost any location on the surface of the container and may lead to failure of the container during or after filling with a beverage. Current methods used for detecting surface flaws or defects such as environmental stress cracks in the surface of a container can be unreliable.

An example of a method used to determine the level of environmental stress cracking in returnable and reusable beverage containers typically involves visual examination by an operator with defect qualification accomplished by comparing the sample to a uniform standard and subjectively assigning a defect severity level to each container. Typically, a crack severity scale of 1 to 4 is used wherein a value of 1 indicates little or no stress cracking and a value of 4 indicates severe stress cracking requiring the bottle to be discarded. Thus, current inspection has the inherent subjectivity of human inspection as well as requiring significant product handling.

If, for example, quantitative data is desired for statistical quality control, the location of defects and preservation of such data must often be obtained and preserved at an additional effort and cost. Visual evaluation is a difficult job and is very tiring for the eyes of the checking personnel, especially when articles produced in large series have to be examined. Also, it is difficult to eliminate subjective influences from visual judgements.

Another known method is the fluorescent crack detection method. The fluorescent crack detection method requires that the container or article to be examined is first prepared so as to reveal the surface defects. The preparation typically consists of applying to the surface of the article a fluorescent or colored dye which penetrates into the openings of the defects on the article surface, then removing the excess dye from the surface. The article is then exposed to electromagnetic radiation causing the dye which has penetrated into the cracks to fluoresce. The presence of the surface defects is then revealed by the emission of a visible fluorescent light by the dye remaining in the cracks.

The florescent crack detection method requires the use of a dye and further requires the container being tested to be removed from a manufacturing or cleaning machine. It is therefore evident that improved systems and methods are needed for detecting defects at the surface of a container, and, particularly, in detecting defects at a surface of a returnable and reusable beverage container.

An object of the invention is to produce a plastic container stress crack detection system which uses ultraviolet radiation to determine the level of environmental stress cracking in a container.

Another object of the invention is to produce a plastic container stress crack detection system, which eliminates the need for a dye.

Another object of the invention is to produce a plastic container stress crack detection system, which can operate on-line and at a high speed during a container manufacturing or cleaning process.

Another object of the invention is to produce a plastic container stress crack detection system, which eliminates the subjective variations in detection resulting from visual inspection of a container.

A further object of the invention is to produce a plastic container stress crack detection system, which can quantify the level of stress cracking in a container.

Yet another object of the invention is to produce a plastic container stress crack detection system which minimizes production and cleaning costs.

Still another object of the invention is to produce a plastic container stress crack detection system, which minimizes product waste.

### SUMMARY OF THE INVENTION

The above, as well as other objects of the invention, may be readily achieved by a method for detecting defects in a surface of a container including: providing a plastic container having a longitudinal axis and a surface; directing ultraviolet radiation from a source to the surface of the container; sensing a portion the radiation reflected from the surface of the container; and generating a signal from the sensed portion of the reflected radiation representing a defect in the surface plastic container.

The above method is typically achieved by a surface defect detection system comprising: a source of ultraviolet radiation; a plastic container having a surface; means for directing the container along a path through the radiation; detecting means for receiving a portion of the ultraviolet radiation reflected from the surface of the plastic container, and being responsive to generate a signal; and a computer means connected to the detecting means and being responsive to the generated signal for calculating a defect value, comparing the defect value with stored standards, and indicating one of acceptance and rejection for said plastic container.

### BRIEF DESCRIPTION OF THE DRAWINGS

The above, as well as other objects, features, and advantages of the present invention will be understood from the detailed description of the preferred embodiments of the present invention with reference to the accompanying drawing, in which:

FIG. 1 is a perspective schematic view of the plastic container stress crack detection system incorporating the features of the invention.

### DETAILED DESCRIPTION OF THE INVENTION

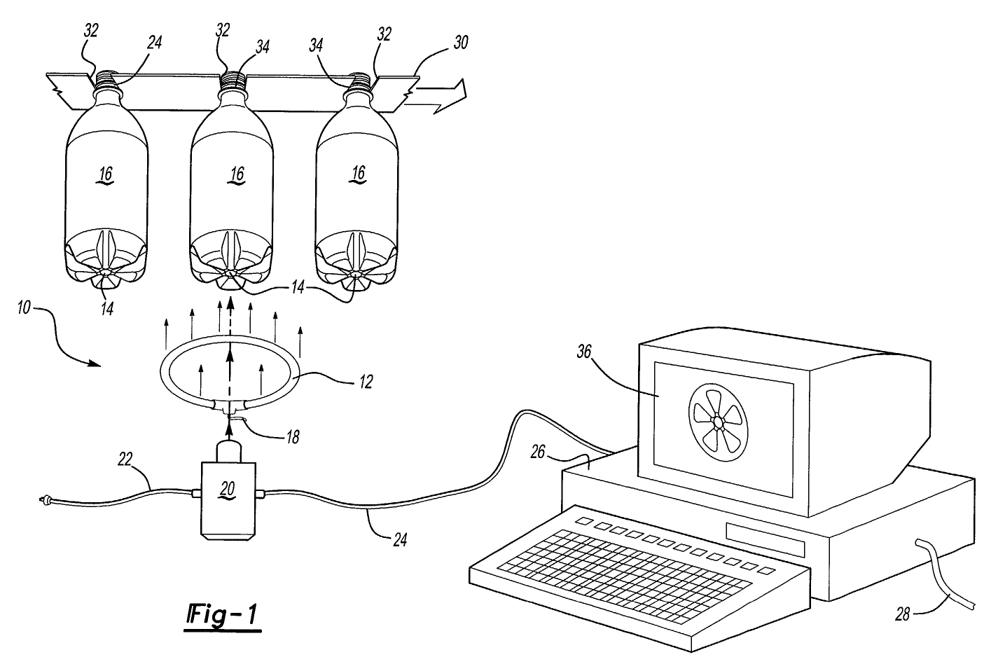

Referring now to FIG. 1, there is shown generally at 10 a plastic container stress crack detection system incorporating the features of the invention. The stress crack detection system 10 includes a source of radiation 12 for emitting light energy, preferably within a range of from visible light to ultraviolet (UV) light, inclusive. The source 12 emits the visible to UV light radiation in the direction of a bottom surface 14 of a plastic container 16, such as a PET blow molded bottle. The source 12 is connected to a power source through a conductor 18. In the embodiment illustrated, the source 12 is a circular bulb, but it will be understood that more than one bulb of a variety of shapes such as tubular, may be used.

The stress crack detection system 10 further includes a detecting means know as a charge-coupled device (CCD) camera 20, such as an Allen-Bradley CVIM™, configurable vision input module, manufactured by Rockwell Automation, Rockwell International Corporation. The CCD camera is disposed on the opposite side of the radiation source 12 from the container 16 for receiving the visible to UV radiation from the surface 14 of the container 16. A CCD is a light-sensitive integrated circuit within the CCD camera 20 that stores the data for an image in such a way that each pixel, or picture element, in the image is converted into an electrical signal. Preferably, the CCD camera 20 will have a minimum window size of about 480 by 480 pixels, and is capable of capturing image data for objects moving a high speed, such as from about two to about twenty objects per second. The CCD camera 20 is coupled to the power source through a conductor 22.

The CCD camera 20 will preferably be positioned at a distance from the container 16 so that the CCD camera 20 can optically observe the entire surface 14 to be inspected. Preferably, the CCD camera 20 will be positioned to optically observe an area of about 100 millimeters by 100 millimeters.

The CCD camera 20 provides an accurate and reliable digital signal, and a sufficient current to drive a shielded, low noise line 24, such as a twisted-wire pair, or a terminated coaxial cable, to a computer 26. The computer 26 is coupled to the power source through a conductor 28.

The container 16 to be detected for surface defects is typically suspended in serial fashion from a conveyor 30 having slots 32 for receiving a finish 34 of the container 16. The conveyor 30 will typically travel at a rate to expose from about two to about twenty containers 16 per second to the UV radiation. In the embodiment shown, the containers 16 are caused to travel such that the visible to UV light radiation from the source 12, and the CCD camera 20 are directed toward the bottom surface 14 of the container 16. However, it will be understood that the UV radiation and the CCD camera 20 may be directed at any exterior or interior surface of the container 16.

The plastic container stress crack detection system 10 operates by directing the UV radiation toward the surface 14 of the container 16. The UV radiation emitted from the source 12 will pass through a pristine portion, or portion of the surface 14 having no defects.

However, when the surface 14 is exposed to the visible to UV radiation, defects such as environmental stress cracks, scuffs, and nicks, appear to be much lighter in color and of higher light intensity than the pristine portions of the surface 14. It has been shown that the effect of defects appearing to be much lighter in color and of higher light intensity is due to a greater amount of light energy being reflected within or directed to the defect than within the pristine portions of the surface 14. Accordingly, defects such as environmental stress cracks appear more intense when exposed to radiation within the range of from visible light to UV light than the pristine portions of the surface 14 of the container 16.

The UV radiation reflected within each defect in the surface 14 of the container 16 is optically observed by the CCD camera 20. The electrical signal generated by the CCD camera 20 is then introduced into the computer 26 by the line 24. The computer 26 includes image processing software for generating an image and performing several mathematical algorithms at production line speeds. The algorithms performed by the computer 26 may include algorithms to determine the density of light present in a stress crack, and a length, a width, and an area of a stress crack.

A minimum size of the stress crack to be observed can be determined by the following equations:

l/p₁

W/p₂

where l is the length of the surface area of the container 16 to be optically observed by the CCD camera 20, w is the width of the surface area of the container 16 to be optically observed by the CCD camera 20, p₁, is the number of pixels corresponding to the length of the window of the CCD camera 20, and P₂ is the number of pixels corresponding to the length of the window of the CCD camera 20.

For example, if the CCD camera 20 is positioned to observe an area of 100 mm by 100 mm, and the CCD camera 20 window size is 480 pixels by 480 pixels, then l/p₁=100 mm/480 pixels=0.21 mm, and w/p₂2=100 mm/480 pixels =0.21 mm . Therefore, it is understood that such a system 10 can detect a stress crack having a length of 0.21 mm or larger, a width of 0.21 mm or larger, and an area of 0.21 mm by 0.21 mm. It has been shown that the system 10 is capable of detecting environmental stress cracks having a width as small as about 0.10 mm.

The UV radiation data received by the CCD camera 20 is then processed by the image processing software of the computer 26, and the resulting image is displayed on a computer monitor 36. The computer 26 then compares the observed values, such as the calculated values representing the density of light present in a stress crack, and the length, width, and area of a stress crack with stored measurement standards. Based on the stored measurement standards, the computer 26 then accepts or rejects each container 16. The computer 26 may also display the inspection result on the computer monitor 34.

While mention has been made that mathematical algorithms will be performed by image processing software within the computer 26, it will be understood that similar results may be achieved by performing the mathematical algorithms within a CCD camera 20 having a suitable microprocessor and associated image processing software within the CCD camera 20.

The principle and mode of operation of this invention have been described in its preferred embodiment. However, it should be noted that this invention may be practiced otherwise than as specifically illustrated and described without departing from its scope.

What is claimed is:

1. A method for detecting defects in a surface of a container including:
providing a plastic container having a longitudinal axis and a surface;
directing ultraviolet radiation from a source to the surface of the container;
sensing a portion the radiation reflected from the surface of the container; and
generating a signal from the sensed portion of the reflected radiation representing a defect in the surface of the container.

2. The method according to claim 1, including directing the plastic container along a path on a conveyor.

3. The method according to claim 1, including sensing the portion of the radiation with at least one vision system responsive to ultraviolet radiation.

4. The method according to claim 3, wherein the vision system is a charge coupled device (CCD) camera.

5. The method according to claim 4, wherein the vision system has a minimum window size of 480 pixels by 480 pixels.

6. The method according to claim 1, wherein said sensing includes performing algorithms for determining the scope of a defect.

7. A surface defect detection system comprising:
a source of ultraviolet radiation;
a plastic container having a surface;
means for directing said container along a path through the radiation;
detecting means for receiving a portion of the ultraviolet radiation reflected from the surface of said plastic container, and being responsive to generate a signal; and
a computer means connected to said detecting means and being responsive to the generated signal for calculating a defect value, comparing the defect value with stored standards, and indicating one of acceptance and rejection for said plastic container.

8. The surface defect detection system according to claim 7, wherein said detecting means comprises at least one vision system responsive to ultraviolet radiation.

9. The surface defect detection system according to claim 8, wherein the vision system is a charge coupled device (CCD) camera.

10. The surface defect detection system according to claim 8, wherein the vision system has a minimum window size of 480 pixels by 480 pixels.

11. The surface defect detection system according to claim 7, wherein said computer means performs algorithms for determining the scope of a defect.

12. The surface defect detection system according to claim 7, including a computer monitor for displaying an inspection result generated by said computer means.
